(19) United States
(12) Patent Application Publication
(10) Pub. No.: US 2026/0287800 A1
(43) Pub. Date: Sep. 24, 2026

(54) OPTICAL DIFFUSER AND MANUFACTURING METHOD

(71) Applicant: STMicroelectronics International N.V., Geneva (CH)

(72) Inventor: Francois GUYADER, Montbonnot (FR)

(73) Assignee: STMicroelectronics International N.V., Geneva (CH)

(21) Appl. No.: 19/563,587

(22) Filed: Mar. 11, 2026

(30) Foreign Application Priority Data
Mar. 19, 2025 (FR) FR2502798

(51) Int. Cl. G02B 5/02

(52) U.S. Cl. CPC G02B 5/0236; G02B 5/0268

(57) ABSTRACT

An optical diffuser includes a lower diffuser layer with a contact pad positioned thereon. The contact pad has a lateral edge with an inclination of less than or equal to 80°. At least one conductive via opening, at least partially filled with a conductive material, extends through the lower diffuser layer to reach a lower surface of the contact pad. A thin conductive track extends on the lower diffuser layer and over the lateral edge of the contact pad.

### PRIORITY CLAIM

This application claims the priority benefit of French Application for Patent No. FR2502798, filed on Mar. 19, 2025, the content of which is hereby incorporated by reference in its entirety to the maximum extent allowable by law.

### TECHNICAL FIELD

The present description relates in general to optical diffusers, as well as the manufacturing methods thereof.

### BACKGROUND

Optical diffusers, such as, for example, diffractive optical elements (DOE) and meta optical elements (MOE), can be used to transmit and orient and/or shape incident light beams passing through them.

They can be used, inter alia, in display or image detection, Light Detection And Ranging (LIDAR), Time of Flight (ToF) applications.

They may comprise a transparent layer located between two anti-reflective layers, this transparent layer having an optical scattering or even diffraction function, by means of scattering structures encapsulated in a transparent material of different refractive index.

They may also comprise a thin conductive track, made of a transparent and electrically conductive material, extending on one face of the diffuser layer. Such a thin conductive track can be connected to an electrical current source, and can thus make it possible to verify the integrity of the optical diffuser. Indeed, an interruption of the electrical current can thus reveal a structural defect of the optical diffuser. Reference is made to United States Patent Application Publication No. 2023/0068198 A1, incorporated herein by reference, which describes an example of such an optical diffuser.

These optical diffusers may be manufactured, for example collectively from the same wafer, by thin film deposition techniques.

However, there is a need to have an optical diffuser, and the manufacturing method thereof, of which the thin conductive track has preserved electrical properties.

### SUMMARY

According to one aspect of the present disclosure, an optical diffuser is proposed comprising: a lower diffuser layer having a first face and a second face, opposite one another, and having a diffusing central area and a non-diffusing peripheral area; at least one contact pad made of an electrically conductive material resting on the second face of the lower diffuser layer facing the peripheral area, and having a lateral edge having an inclination of less than or equal to 80° in relation to a plane parallel to the second face; at least one conductive via made of an electrically conductive material passing through the lower diffuser layer from the first face until opening onto a lower surface of the contact pad; and a thin conductive track made of a transparent and electrically conductive material extending on the second face of the lower transparent layer and extending on the lateral edge to cover at least partially the contact pad.

The thin conductive track may comprise a trace having a first nominal thickness, located facing the diffusing central area, and the contact pad may have a second nominal thickness between the upper surface thereof and the upper surface of the thin diffuser layer, the first nominal thickness of the thin conductive track being less than or equal to 1.5 times the second nominal thickness of the contact pad, and preferably less than or equal to the second nominal thickness of the contact pad.

The first nominal thickness of the thin conductive track may be greater than or equal to 10 nm.

The second nominal thickness of the contact pad may be between 10 nm and 100 nm.

The thin conductive track may comprise an end portion which completely covers the contact pad and may surround the latter all around the periphery thereof.

The inclination of the lateral edge of the contact pad may be constant over the entire thickness of the contact pad, that is to say over the entire height of the lateral edge.

The inclination of the lateral edge of the contact pad may have a first value from the lower surface thereof and at least one additional inclination in the direction of the upper surface, each inclination being less than the previous inclination.

The inclination of the lateral edge of the contact pad may be greater than or equal to 45°.

The optical diffuser may comprise an encapsulation layer covering the thin conductive track and the lower diffuser layer, and a transparent substrate assembled to the encapsulation layer.

The contact pad may be made of at least one material selected from Ti, TiN, W, TiW, Ta, TaN.

The thin conductive track may be made of a conductive transparent oxide, such as indium tin oxide (ITO), fluorine-doped tin oxide (FTO), or aluminum-doped zinc oxide (AZO) or gallium-doped zinc oxide.

According to another aspect, a method for manufacturing an optical diffuser is proposed according to any one of the preceding features, comprising the following steps of: producing the lower diffuser layer; producing the contact pad, by depositing a first continuous layer then localized etching to form the contact pad; producing the thin conductive track, by depositing a second continuous layer then localized etching to form the thin conductive track; and producing the conductive via through a through-hole made by localized etching through the thin diffuser layer to open onto a lower surface of the contact pad.

The second continuous layer can be produced by physical vapor deposition. The first continuous layer may be etched by dry etching.

### BRIEF DESCRIPTION OF THE FIGURES

Other advantages and features of the invention will become apparent upon examining the detailed description of non-limiting embodiments and implementations, and from the appended drawings wherein:

FIG. 1A is a schematic and partial cross-sectional view of an optical diffuser;

FIG. 1B is a schematic and partial top view of the thin conductive track of the optical diffuser of FIG. 1A;

FIG. 2A is a schematic and partial top view, illustrating in more detail an end portion of the thin conductive track covering a contact pad of the optical diffuser of FIG. 1B;

FIG. 2B is a schematic and partial cross-sectional view, illustrating in more detail the thin conductive track covering a lateral edge of the contact pad of the optical diffuser of FIG. 1A;

FIG. 2C is a schematic and partial cross-sectional view, illustrating in more detail the thin conductive track covering a lateral edge of the contact pad of the optical diffuser; and

FIGS. 3A-3G illustrate various steps of a method for manufacturing an optical diffuser.

### DETAILED DESCRIPTION

In the figures and in the following description, the same references represent identical or similar elements. In addition, the various elements are not plotted to scale so as to favour clarity of the figures. Moreover, the various embodiments and alternative embodiments are not exclusive of each other and may be combined together.

Unless indicated otherwise, the terms “substantially”, “about”, “in the order of” mean within a 10% margin, and preferably within a 5% margin. Moreover, the terms “between … and …” and equivalent mean that the bounds are comprised, unless stated otherwise.

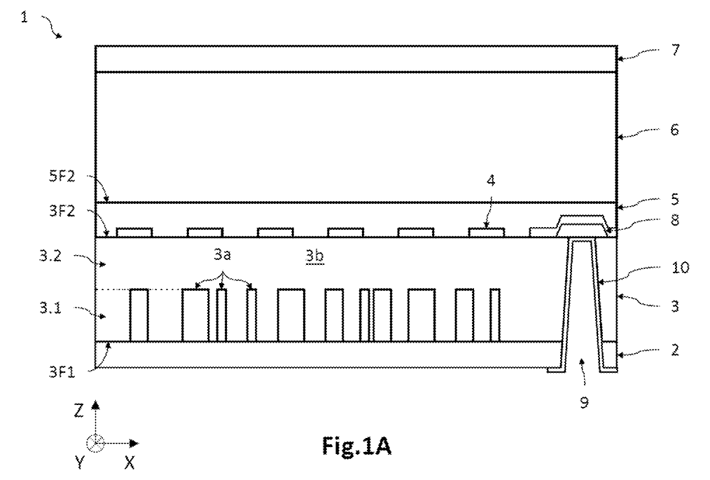

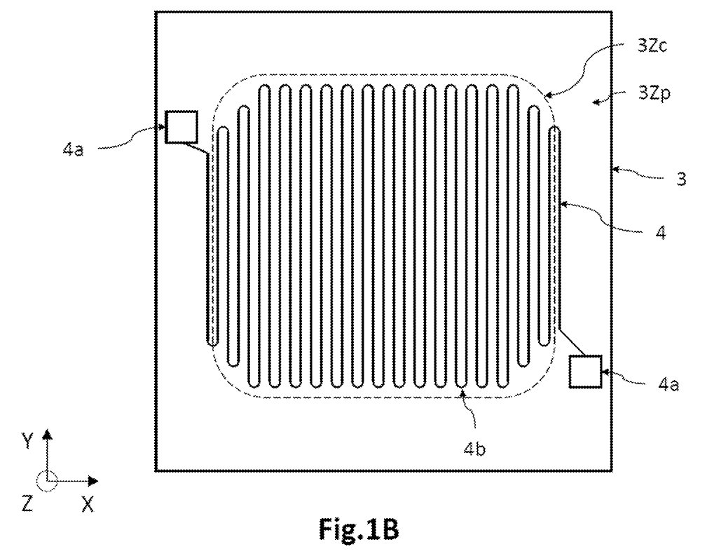

FIG. 1A is a schematic and partial view of an optical diffuser 1.

Herein and for the remainder of the description, a three-dimensional direct reference XYZ is defined, where the XY plane is parallel to a main plane of the optical diffuser 1, and where the axis Z is oriented according to the thickness thereof. Furthermore, the terms “lower” and “upper” are understood to be relative to an increasing positioning along the direction +Z.

By way of example, an optical diffuser 1 may be intended to transmit and shape and/or orient an incident light beam. It may be a continuous or pulsed light beam, for example a laser beam, the wavelength of which may be comprised in the spectral range of Near Infrared (NIR) ranging from about 780 nm to 2,500 nm. For example, the working wavelength may be equal to 940 nm.

In this embodiment, the optical diffuser 1 comprises: a lower diffuser layer 3, a thin conductive track 4 located in an encapsulation layer 5, and a transparent substrate 6. This stack is located between two anti-reflective layers 2, 7. In addition, conductive vias 10 pass through the lower diffuser layer 3 to come into contact with the thin conductive track 4.

The lower diffuser layer 3 has an optical function of scattering or even diffraction of the incident light beam. It comprises diffuser structures 3a encapsulated in a transparent and electrically insulating filler material 3b. The material of the diffuser structures 3a and the filler material 3b have different refractive indices.

In general, transparent means that the transmission coefficient of the material considered, at a working wavelength that depends on the intended application, is at least equal to 50%, or even 75%, or even 90% or more.

The lower diffuser layer 3 has two flat faces, opposite one another, a lower face 3F1 and an upper face 3F2. The thickness of the lower diffuser layer 3 is substantially constant in the XY plane. It can be in the order of several hundred nanometers to a few microns. In one embodiment, it is between 1 and 2 µm, and may be equal to about 1.5 µm.

The lower diffuser layer 3 is formed, along the axis Z, of a lower part 3.1 and of an upper part 3.2 which covers the lower part 3.1.

The lower part 3.1 extends vertically from the lower face 3F1. It comprises the diffuser structures 3a. It may have a thickness in the order of several hundred nanometers, for example between 500 nm and 1 µm, and here equal to about 700 nm.

The diffuser structures 3a are here studs or pillars made of silicon, for example of polycrystalline silicon or amorphous silicon, which extend vertically from the lower face 3F1. By way of example, the diffuser structures 3a may have, along the axis Z, the same height which is here substantially equal to the thickness of the lower part 3.1 of the lower diffuser layer 3.

The upper part 3.2 does not comprise diffuser structures 3a. It extends vertically from the lower part 3.1 to the upper face 3F2. It may have a thickness in the order of several hundred nanometers, for example between 500 nm and 1 µm, and here equal to about 800 nm. Thus, it ensures here a non-zero spacing between the upper surface of the diffuser structures 3a and the upper face 3F2, so that the diffuser structures 3a are not flush therewith.

The filler material 3b may be a nitride or an oxide, for example a silicon oxide. It surrounds the diffuser structures 3a in the horizontal XY plane in the lower part 3.1, and forms the upper part 3.2.

In the XY plane, the lower diffuser layer 3 has a diffusing central area, where the diffuser structures 3a are located, which is surrounded by a non-diffusing peripheral area 3Zp. The contact pads 8 are located in the peripheral area 3Zp, and the thin conductive track 4 (trace 4b) extends essentially in the central area 3Zc. These two areas 3Zc and 3Zp are illustrated in FIG. 1B.

A thin conductive track 4 rests and extends on the upper face 3F2 of the lower diffuser layer 3, and is essentially present facing the central area 3Zc where the diffuser structures 3a are located. It is intended to be connected to a power source (not shown), via the contact pads 8 and the conductive vias 10, to make it possible for an electrical current to flow.

This track 4 is made of a transparent and electrically conductive material, such as oxide (TCO). Preferably, it is an indium tin oxide (ITO), but it may also be a fluorine-doped tin oxide (FTO), an aluminum-doped zinc oxide (AZO) or even gallium-doped zinc oxide (GTO), inter alia.

This is a track (or line) insofar as, in the XY plane, the length thereof is greater than the width thereof. The thin conductive track 4 extends in the XY plane between two end portions 4a, which are located facing the peripheral area 3Zp. The end portions 4a are in contact with contact pads 8, to ensure the electrical connection of the thin conductive track 4. The part which forms the trace of the thin conductive track 4, which is located essentially facing the central area 3Zc, is noted at reference 4b.

The thin conductive track 4 is said to be thin insofar as it has a nominal thickness e_{n,pmc} in the order of a few tens to hundreds of nanometers, for example between 10 nm and 200 nm, preferably between 10 nm and 100 nm, for example equal to 40 nm, the thickness thereof being less than the length and width thereof. In this thickness range, the thin conductive track 4 has a good compromise between transparency and electrical resistance.

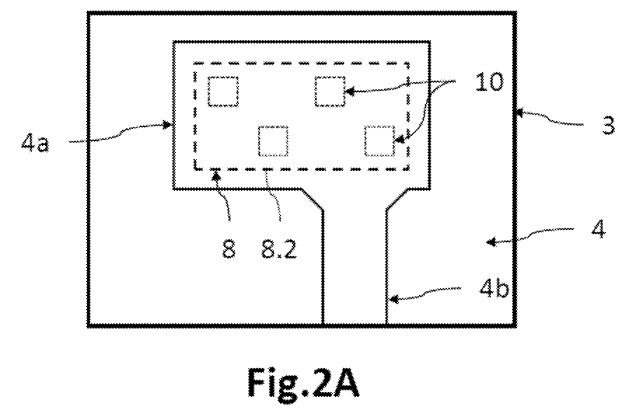

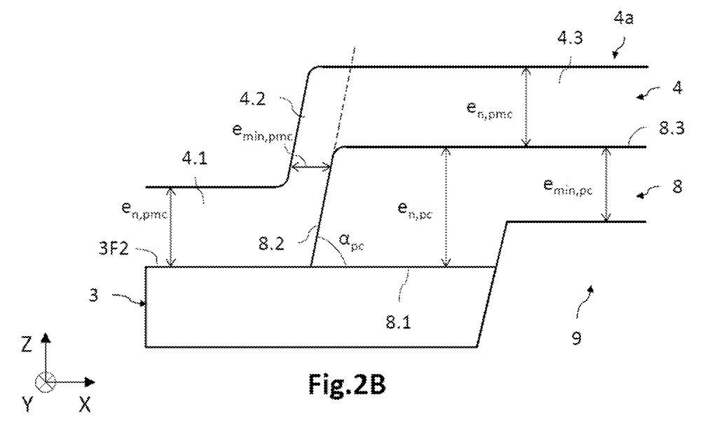

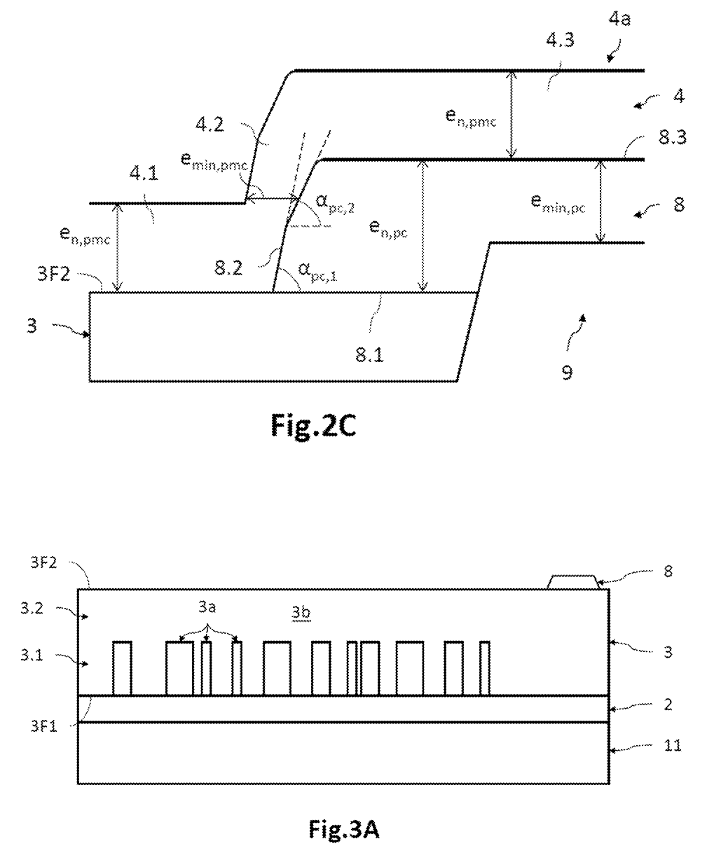

The nominal thickness e_{n,pmc} of the thin conductive track 4 is the thickness of the trace 4b. As explained further with reference to FIGS. 2B and 2C, the thin conductive track 4 has a minimum thickness e_{min,pmc} at the lateral edge of the contact pad 8.

An encapsulation layer 5 completely covers the thin conductive track 4 and extends over the lower diffuser layer 3. It has a flat upper face 5F2, opposite the upper face 3F2.

The maximum thickness of the encapsulation layer 5, measured between the two upper faces 3F2 and 5F2, may be in the order of a few hundred nanometers, for example between 200 and 1,000 nm, here equal to about 300 nm.

The encapsulation layer 5 is made of a transparent and electrically insulating material, for example an oxide such as a silicon oxide.

In this example, a transparent substrate 6, made of a transparent material, for example glass, is assembled to the upper face 5F2 of the encapsulation layer 5, for example here by direct bonding.

It has a thickness in the order of several tens to hundreds of microns, for example a thickness equal to about 200 µm.

It should be noted that direct bonding, also called molecular bonding or molecular adhesion bonding, is the bonding of two layers in contact with each other, without the addition of a specific adhesive material such as a resin or a polymer, but by means of the attractive forces of atomic or molecular interaction between the surfaces to be bonded, such as Van der Waals forces or covalent or metallic bonds. This is a spontaneous bonding process, which, like here, may be temperature-assisted.

Consolidation annealing may accompany or follow the direct bonding step so as to improve the bonding strength. Such consolidation annealing may be carried out at about 380° C for a time of about 2 hours.

A first anti-reflective layer 2 extends over the lower face 3F1 of the lower diffuser layer 3. A second anti-reflective layer 7, identical or similar to the first anti-reflective layer 2, extends over the upper face of the transparent substrate 6.

Each of the anti-reflective layers 2, 7 may be formed from an alternation of elementary layers in transparent and electrically insulating materials, having different refractive indices, for example silicon oxide and silicon nitride.

FIG. 1B illustrates an example of a thin conductive track 4, which extends in the shape of a coil or serpentine shape on the upper face 3F2 of the lower diffuser layer 3. Of course, it may extend in various ways, for example in a spiral shape.

As illustrated, the end portions 4a are located facing the non-diffusing peripheral area 3Zp, and the serpentine trace 4b is located facing the diffusing central area 3Zc.

Contact pads 8 rest on the upper face 3F2 of the lower diffuser layer 3, and are located facing the non-diffusing peripheral area 3Zp.

They are in electrical contact, and here in physical contact, with the end portions 4a of the thin conductive track 4, which cover them at least partially. In other words, the end portions 4a extend on and in contact with the contact pads 8.

The pads 8 are made of an electrically conductive material, which is also configured to provide the etching stop function during the step of forming the through-holes 9 to form the conductive vias 10. They may be made of titanium Ti, titanium nitride TiN, tungsten W or TiW, tantalum Ta or tantalum nitride TaN, inter alia. Preferably, each contact pad is made of TiN.

With additional reference to FIG. 2B, the contact pads 8 have a lower surface 8.1 which rests on the thin diffuser layer 4, a substantially flat upper surface 8.3, and a lateral edge 8.2. The lateral edge 8.2 forms a surface which extends in the XY plane along the periphery of the contact pad 8, and along the axis Z between the lower surface 8.1 and the upper surface 8.3.

Each contact pad 8 has a nominal thickness e_{n,pc}, which is defined as the vertical distance between the lower surface 8.1 thereof and the upper surface 8.3 thereof. This nominal thickness e_{n,pc} may be between 10 nm (in the absence of an overetching mentioned below) and 100 nm. Preferably, it is equal to about 55 nm.

The minimum value of the nominal thickness e_{n,pc} depends in particular on the possible presence of an overetching that the contact pad may undergo, at the lower surface 8.1 thereof, when producing the through-holes 9. In the case of an overetching of 30 nm, a nominal thickness e_{n,pc} of 55 nm may be provided so that a reduced thickness e_{min,pc} of 10 to 20 min minimum remains at the level of the overetching. In the absence of overetching, the nominal thickness e_{n,pc} may be at least 10 nm, and preferably at least 20 nm.

The maximum value of the nominal thickness e_{n,pc}, preferably here of 100 nm, is selected to limit the series resistance between the conductive material of the conductive via (e.g. Au and Ti), the conductive material of the contact pad (e.g. TiN), and the conductive material of the thin conductive track (e.g. ITO). It also makes it possible to avoid removing too much material during the step of planarising the upper face 5F2 of the encapsulation layer 5.

Finally, conductive vias 10 pass through the anti-reflective lower layer 2 and the lower diffuser layer 3 to open out on contact with the lower surface 8.1 of the contact pads 8. These conductive vias 10 extend into through-holes 9 and are made of at least one electrically conductive material. They ensure the electrical connection of the thin conductive track 4 with the external power source.

FIG. 2A illustrates an example of covering a contact pad 8 by an end portion 4a of the thin conductive track 4. Also illustrated are the contact areas of the conductive vias 10 with the lower surface of the contact pad 8. In this example, the contact areas have dimensions of about 10 µm by 10 µm. A plurality of conductive vias 10 come into contact here with the same contact pad 8.

The end portion 4a covers the upper surface of the contact pad 8, goes down on one side of the lateral edge 8.2 thereof, and continues in the form of a trace 4b. Preferably, it covers not only one, but a plurality of sides of the lateral edge 8.2, and here the four sides. This makes it possible to reduce the risks of electrical conduction defect of the end portion 4a in the part where it goes down the lateral edge 8.2.

It is noted that, in the absence of such a contact pad 8, the production of each opening hole 9 to form the conductive via 10 may lead to a degradation of the thin conductive track 4.

Indeed, in this situation where the contact pad 8 would be absent, the hole-orifice 9 opens directly onto a lower surface of the end portion of the thin conductive track 4.

However, insofar as, on the one hand, the lower diffuser layer 3 has a significant thickness, for example in the order of 1.5 µm, and that, on the other hand, the thin conductive track 4 has a low thickness, for example in the order of 40 nm, the dry etching carried out to form the through-hole 9 can also etch a non-negligible part of the thickness of the thin conductive track 4. This would then degrade the electrical properties of the thin conductive track 4, in particular by increasing the electrical resistance thereof.

A solution would therefore be to provide a contact pad 8 which provides both the engraving stop function and the electrical conduction function between the conductive via 10 and the end portion of the thin conductive track 4.

However, it has been found that such a contact pad 8, which would be produced conventionally, that is to say with a lateral edge 8.2 substantially orthogonal (i.e., forming an angle in the order of 90° in relation to the plane of the upper face 3F2), may lead to a situation that would not be entirely satisfactory.

Indeed, in this solution, it has been found that the end portion 4a may have insufficient thickness when passing the lateral edge 8.2 of the contact pad 8. This phenomenon could be due to the fact that the thin conductive layer, intended to form the track 4, then deposited by physical vapor deposition (PVD), would form an overhang at the junction between the upper surface 8.3 and the lateral edge 8.2 of the contact pad. Such an overhang can generate a shadowing phenomenon resulting in an excessive reduction in the local thickness of the thin conductive layer below the overhang.

To avoid this damage, the contact pad 8 has an inclined lateral edge, with an inclination angle α_{pc} less than or equal to 80° in relation to the plane of the upper face 3F2. It appears that the risk of such an overhang forming is then highly limited.

Thus, a step coverage (SC) parameter can be defined as the ratio between the reduced thickness e_{min,pmc} of the end portion 4a of the thin conductive track 4 on the lateral edge 8.2 of the contact pad 8 and the nominal thickness e_{n,pmc} of this same end portion 4a on the upper surface 8.3: SC = e_{min,pmc} / e_{n,pmc}. According to one embodiment, a value of at least 40% of the SC parameter is sought, and preferably at least 50%.

This SC parameter makes it possible to evaluate the quality of the compliant PVD-type deposition of the thin conductive layer (intended to form the thin conductive track 4) on the contact pad 8.

Thus, it appears that a lateral edge 8.2 of the contact pad with an inclination angle α_{pc} less than or equal to 80° makes it possible to obtain a value of at least 40% of the SC parameter.

Thus, it was found that an inclination angle α_{pc} of about 76° of the lateral edge 8.2 of the contact pad, the latter having a nominal thickness e_{n,pc} of about 57 nm, with a thin conductive track 4 of nominal thickness e_{n,pmc} of about 41 nm, leads to a reduced thickness e_{min,pmc} of 23 nm and therefore to a SC parameter of 56%. Thus, the compliant deposition can be qualified as having a good quality. In addition, the reduced thickness of 23 nm of the end portion 4a makes it possible to obtain sufficient local electrical resistance.

Preferably, the inclination of the lateral edge 8.2 of the contact pad is greater than or equal to 45°. It is thus avoided that residues of the material of the contact pad 8 remain present on the upper face 3F2, following the step of etching a continuous layer to form the contact pads 8.

FIG. 2B illustrates a part of a contact pad 8 covered by the end portion 4a of the thin conductive track 4, for an optical diffuser 1 according to one embodiment. Of course, the figure is schematic.

The contact pad 8 rests on the lower diffuser layer 3 at the lower surface 8.1 thereof. It has a substantially flat upper surface 8.3, and a lateral edge 8.2. It has a nominal thickness e_{n,pc} outside the overetching caused by producing the through-hole 9, and a reduced thickness e_{min,pc} at the overetching.

In general, the nominal thickness e_{n,pc} may be at most equal to 100 nm. The minimum value thereof depends on the overetching when producing the through-hole 9, so that the reduced thickness can be at least equal to about 10 nm. In this example, the contact pad 8 is made of TiN and has a nominal thickness e_{n,pc} of about 55 nm, and a reduced thickness e_{min,pc} of about 25 nm.

The surface of the lateral border 8.2 is inclined with an inclination angle α_{pc} less than or equal to 80° in relation to the face 3F2 of the lower diffuser layer 3. In this example, this inclination angle α_{pc} is about 75°. It is substantially constant over the entire thickness of the contact pad 8.

The end portion 4a of the thin conductive track 4 covers the contact pad 8, that is to say it is formed by a top part 4.3 located on the upper surface 8.3 of the contact pad, an inclined part 4.2 located on the lateral edge 8.2, and a bottom part 4.1 located on the lower diffuser layer 3. It has a nominal thickness e_{n,pmc} (measured along the axis Z) in the top 4.3 and bottom 4.1 parts thereof, and a reduced thickness e_{min,pmc} (measured along the XY plane) in the inclined part thereof.

In general, the nominal thickness e_{n,pmc} of the thin conductive track may be between 10 nm and 200 nm. However, preferably, this nominal thickness e_{n,pmc} is at least equal to 20 nm. Furthermore, it may be less than or equal to 1.5 times the nominal thickness e_{n,pc} of the contact pad: e_{n,pmc} ≤ 1.5×e_{n,pc}, and preferably, the nominal thickness e_{n,pc} is such that: e_{n,pmc} ≤ e_{n,pc}. In this example, it is equal to about 41 nm, and the reduced thickness e_{min,pmc} is about 23 nm. Thus, a SC parameter of about 56% is obtained.

FIG. 2C illustrates a part of a contact pad 8 covered by the end portion 4a of the thin conductive track 4, for an optical diffuser 1 according to another embodiment. Of course, the figure is schematic.

Here, the lateral border 8.2 may have several successive inclinations, all less than or equal to 80°. Preferably, it has a first inclination α_{pc,1} from the lower surface 8.1, then at least one additional inclination α_{pc}, lower than the previous inclination, up to the upper surface 8.3.

In this example, the lateral edge 8.2 has a first inclination α_{pc,1}, here of about 80°, over a first height, here substantially equal to half of the nominal thickness e_{n,pc}, followed by a second inclination α_{pc,2}, here of about 65° over a second height, here substantially equal to half of the nominal thickness e_{n,pc}.

It appears that the fact of forming several successive inclinations which gradually decrease in the direction of the upper surface 8.3 makes it possible to further improve the SC parameter, thus improving the electrical properties (electrical resistance) of the thin conductive track 4.

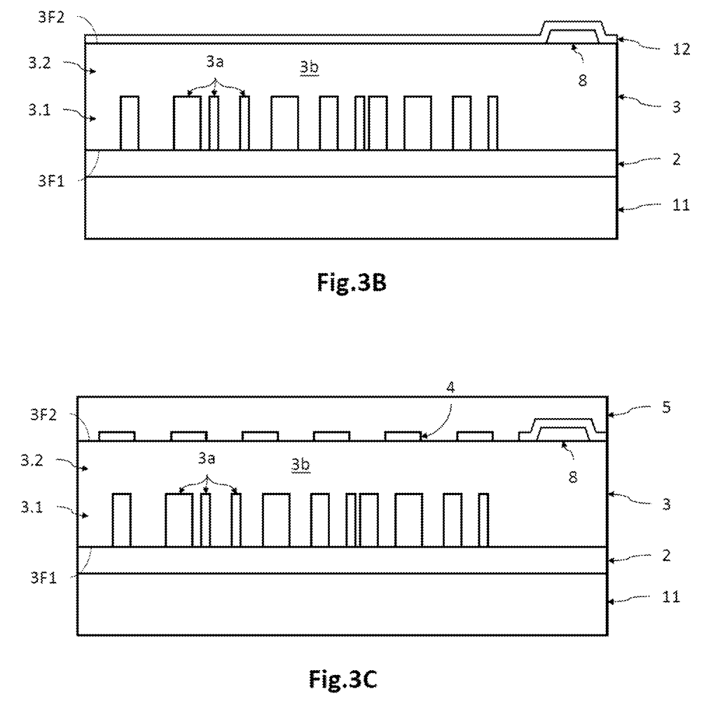

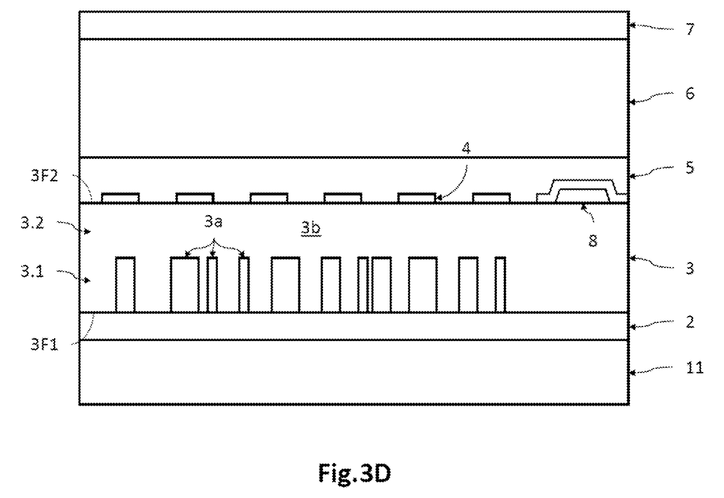

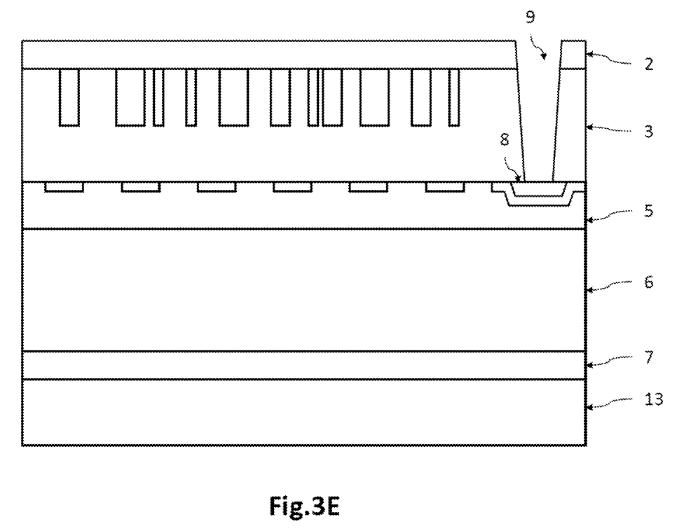

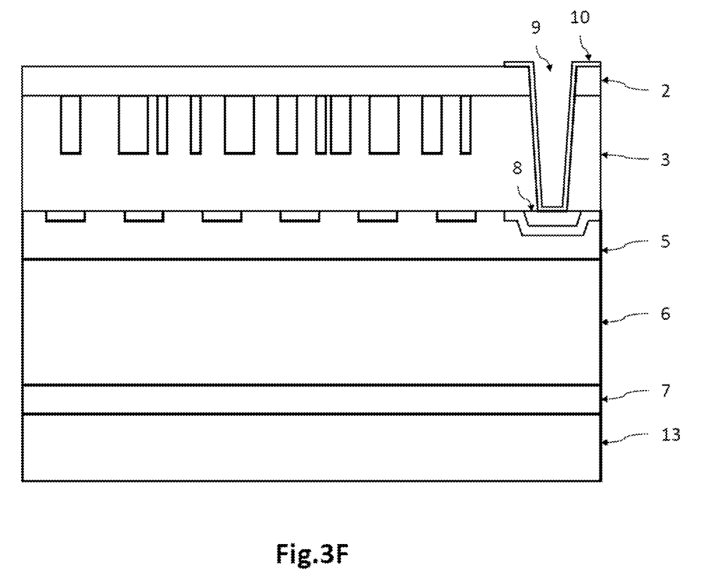

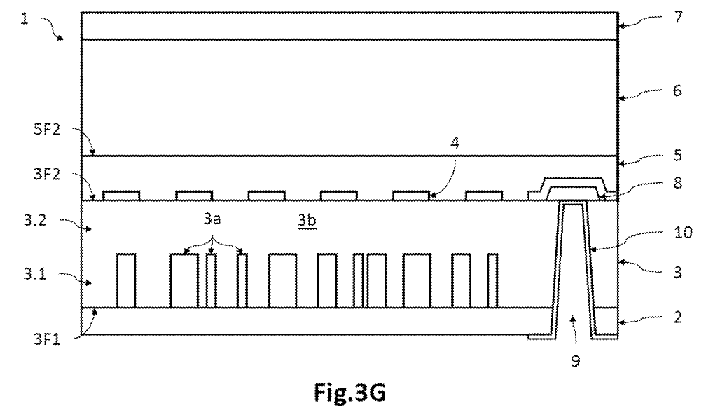

FIGS. 3A-3G illustrate an example of steps of a method for manufacturing an optical diffuser according to one embodiment.

As indicated previously, the optical diffuser 10 is formed at least by a stack of a lower diffuser layer 3 and of a thin conductive track 4. Contact pads 8 are located facing the peripheral area 3Zp, and are in contact with the thin conductive track 4 at the end portions 4a thereof on the one hand, and with the conductive vias 10 thereof on the other hand.

According to one embodiment, the optical diffuser 1 also comprises a transparent substrate 6 assembled to the encapsulation layer 5 by temperature-assisted direct bonding.

With reference to FIG. 3A, a first anti-reflective layer 2 is produced from a support substrate 11. This may be produced based on silicon, and the anti-reflective layer may be formed by an alternation of elementary thin layers (sublayers) of materials having different refractive indices, such as for example nitride and silicon oxide.

The lower diffuser layer 3 is subsequently produced. For this purpose, a first continuous layer (not shown) made of a transparent and electrically insulating material, for example an oxide such as SiO, is produced on the anti-reflective layer 2. Diffuser structures 3a (here diffractive), such as studs or pillars, are made through the first continuous layer. Finally, a new deposition of the material of the continuous layer is performed so as to surround the diffuser structures 3a and thus form the lower part 3.1, and to completely cover the diffuser structures 3a and thus form the upper part 3.2. Finally, a step of chemical mechanical planarization (for example, of chemical mechanical polishing (CMP) type) may be performed to planarize the upper face 3F2 of the lower diffuser layer 3.

Finally, contact pads 8 are produced. They rest on the upper face 3F2 and are located facing the peripheral area 3Zp. In this example, the contact pads 8 are produced by depositing a continuous layer of TiN, which is subsequently structured by dry etching (for example a reactive ion etch (RIE) type etching) to form the contact pads 8. Each contact pad 8 here has a thickness of for example 55 nm, and the lateral edge 8.2 is inclined by an angle of inclination less than or equal to 80°. The inclination may be obtained by a certain polymerization rate of the dry etching.

With reference to FIG. 3B, a thin conductive layer 12 is subsequently produced intended to form the thin conductive track 4. The thin conductive layer 12 is produced so as to cover the upper face 3F2 of the lower diffuser layer 3, and also continuously covers the contact pads 8.

In this example, the thin conductive layer 12 is made of ITO, and has a nominal thickness e_{n,pmc} of about 40 nm. It can be produced by physical vapor deposition (PVD) at a temperature of for example 150° C, inter alia. As indicated previously, it may have a reduced thickness e_{min,pcm} of about 20 nm at the inclined lateral edge 8.2 of the contact pad 8, so that the SC parameter is at least 40%, and here in the order of 50%.

With reference to FIG. 3C, the thin conductive track 4 is subsequently produced, by lithography and etching. For this purpose, an engraving mask (resin, not shown) is created to define the areas to be engraved. Then, the unprotected portions of the thin conductive layer 12 are etched, with an etching stop on the oxide of the lower diffuser layer 3. The engraving mask is subsequently deleted. Thus, a thin conductive track 4 is obtained.

An encapsulation layer 5 is subsequently produced (ECE), which extends over and covers the lower diffuser layer 3, and the thin conductive track 4. The encapsulation layer 5 is made of an electrically insulating transparent material, such as an oxide or a nitride. It is preferably a material having the same refractive index as that of the thin conductive track 4, so as to limit the parasitic reflections. This is preferably a TEOS. The thickness thereof from the lower diffuser layer 3 may be from several hundred nanometers to a few microns, for example equal to about 1 µm. Planarization of the upper face thereof is carried out with a view to direct bonding, for example in a chemical mechanical (CMP) manner.

With reference to FIG. 3D, an assembly of a transparent substrate 6, here made of glass, is performed on the free face of the encapsulation layer 5, by direct bonding. Consolidation annealing EET2 is carried out at a temperature T2 higher than the ambient temperature, at least higher than 300° C, preferably between 300° C and 400° C, for a duration Δt2 at least equal to 60 min, here at 380° C for 120 min. Consolidation annealing EET2 may be carried out during or after contacting the surfaces to be bonded.

Manufacturing of the optical diffuser 1 is subsequently completed. For this purpose, a second anti-reflective layer 7 is produced, here on the upper face of the transparent substrate 6. Like the first anti-reflective layer 2, it can be produced by alternating SiN and SiO underlayers.

With reference to FIG. 3E, a temporary handle 13 is subsequently assembled to the free upper face of the anti-reflective layer 7, and the support substrate 11 is removed, for example by grinding followed by wet cleaning. The structure is subsequently turned over.

The through-holes 9 are produced with a view to forming the conductive vias 10. These through-holes 9 are subsequently produced, by dry etching, in the peripheral area 3Zp, through the anti-reflective layer 2 (thickness here of about 250 nm) and the lower diffuser layer 3 (thickness here of about 1.5 µm), until they open onto the lower surface 8.1 of the contact pads 8. Possible over-engraving is not illustrated here. The contact pads 8 thus ensure an etching stop function, and thus protect the thin conductive layer 12 from any damage.

With reference to FIG. 3F, conductive vias 10 are subsequently produced. In this example, they are produced by the compliant PVD deposition of one or more thin layers of metallic materials, for example a first thin layer of Ti of about 50 nm of thickness, followed by a second thin layer of gold Au of about 200 nm thickness. An etching step is subsequently carried out to keep only the peripheral portions of these thin layers which surround the through-holes 9. These peripheral portions thus enable the electrical connection to a power source to circulate an electrical current in the thin conductive track.

With reference to FIG. 3G, the structure is subsequently turned over, then the temporary handle 13 is removed. Thus, an optical diffuser is obtained where the thin conductive track 4 is in electrical contact, by the contact pads 9, with the conductive vias 10 which extend through the thin diffuser layer 3. Due to the inclined lateral edge 8.2 of the contact pads, the thin conductive track 4 has a good SC parameter, and therefore good electrical properties.

In the case of a method for collectively (i.e. simultaneously) manufacturing a plurality of optical diffusers 1, from the same wafer, the method ends with dicing so as to separate the optical diffusers 1 from one another. It is therefore understood that the steps described above are performed at the scale of the wafer.

Embodiments have just been described. Various alternative embodiments and modifications will appear to the person skilled in the art.

1. An optical diffuser, comprising:
a lower diffuser layer having a first face and a second face opposite the first face, said lower diffuser layer having a diffusing central area and a non-diffusing peripheral area;
at least one contact pad made of an electrically conductive material, said at least one contact pad resting on the second face of the lower diffuser layer facing the peripheral area, wherein the at least one contact pad has a lateral edge having an inclination of less than or equal to 80° in relation to a plane parallel to the second face;
at least one conductive via, made of an electrically conductive material, passing through the lower diffuser layer from the first face and in contact with a lower surface of the contact pad; and
a thin conductive track made of a transparent and electrically conductive material that extends on the second face of the lower transparent layer and extends on the lateral edge to cover at least partially the at least one contact pad.

2. The optical diffuser according to claim 1, wherein the thin conductive track comprises a trace having a first thickness, said trace located facing the diffusing central area, and wherein the at least one contact pad has a second thickness between an upper surface thereof and the upper surface of the lower diffuser layer, wherein the first thickness of the thin conductive track is less than or equal to 1.5 times the second thickness of the at least one contact pad.

3. The optical diffuser according to claim 2, wherein, the first thickness of the thin conductive track is less than or equal to the second thickness of the at least one contact pad.

4. The optical diffuser according to claim 2, wherein the first thickness of the thin conductive track is greater than or equal to 10 nm.

5. The optical diffuser according to claim 4, wherein the second thickness of the at least one contact pad is between 10 nm and 100 nm.

6. The optical diffuser according to claim 1, wherein the thin conductive track comprises an end portion which completely covers the at least one contact pad and surrounds the at least one contact pad along an entire periphery thereof.

7. The optical diffuser according to claim 1, wherein the inclination of the lateral edge of the at least one contact pad is constant over an entire thickness of the at least one contact pad.

8. The optical diffuser according to claim 1, wherein the inclination of the lateral edge of the at least one contact pad has a first inclination from the lower surface thereof and at least one additional inclination in the direction of the upper surface, each additional inclination being less than a previous inclination.

9. The optical diffuser according to claim 1, wherein the inclination of the lateral edge of the contact pad is greater than or equal to 45°.

10. The optical diffuser according to claim 1, comprising an encapsulation layer covering the thin conductive track and the lower diffuser layer, and a transparent substrate assembled to the encapsulation layer.

11. The optical diffuser according to claim 1, wherein the contact pad is made of at least one material selected from the group: Ti, TiN, W, TiW, Ta, TaN.

12. The optical diffuser according to claim 1, wherein the thin conductive track is made of a conductive transparent oxide selected from the group: indium tin oxide, fluorine-doped tin oxide, aluminum-doped zinc oxide, gallium doped zinc oxide.

13. A method for manufacturing an optical diffuser, comprising steps of:
producing a lower diffuser layer;
producing a contact pad by depositing a first continuous layer on the lower diffuser layer followed by a localized etching to form the contact pad, the contact pad having a lateral edge with an inclination of less than or equal to 80° in relation to a plane parallel to a surface of the lower diffuser layer;
producing a thin conductive track by depositing a second continuous layer on the lower diffuser layer and contact pad followed by a localized etching to form the thin conductive track; and
producing a conductive via extending through the lower diffuser layer by forming a through-hole by localized etching extending through the lower diffuser layer to reach a lower surface of the contact pad followed by at least partially filling the through-hole with a conductive material that is in contact with the contact pad.

14. The method according to claim 13, wherein depositing the second continuous layer comprises performing a physical vapor deposition.

15. The method according to claim 13, wherein the localized etching of the first continuous layer to form the contact pad comprises performing a dry etching.

16. The method according to claim 13, wherein the thin conductive track comprises a trace having a first thickness, and wherein the at least one contact pad has a second thickness between an upper surface thereof and the surface of the lower diffuser layer, wherein the first thickness of the thin conductive track is less than or equal to 1.5 times the second thickness of the at least one contact pad.

17. The method according to claim 16, wherein, the first thickness of the thin conductive track is less than or equal to the second thickness of the contact pad.

18. The method according to claim 13, wherein the inclination of the lateral edge of the contact pad is constant over an entire thickness of the contact pad.

19. The method according to claim 13, wherein the inclination of the lateral edge of the contact pad has a first inclination from the lower surface thereof and at least one additional inclination in the direction of the upper surface, each additional inclination being less than a previous inclination.
